(19) United States
(12) Patent Application Publication
(10) Pub. No.: US 2024/0250798 A1
(43) Pub. Date: Jul. 25, 2024

(54) METHOD AND APPARATUS FOR HANDLING UL TIMING ALIGNMENT UPON RECEIVING TCI STATE UPDATE SIGNAL IN A WIRELESS COMMUNICATION SYSTEM

(71) Applicant: Samsung Electronics Co., Ltd., Suwon-si, Gyeonggi-do (KR)

(72) Inventors: Anil AGIWAL, Suwon-si (KR); Jaehyuk JANG, Suwon-si (KR)

(21) Appl. No.: 18/562,610

(22) PCT Filed: Jun. 24, 2022
(86) PCT No.: PCT/KR2022/009003

§ 371 Date: Nov. 20, 2023

(30) Foreign Application Priority Data
Jun. 24, 2021 (KR) 10-2021-0082423

(51) Int. Cl. H04L 5/00; H04W 56/00; H04W 74/0833

(52) U.S. Cl. CPC H04L 5/0094; H04W 56/0045; H04W 74/0833

(57) ABSTRACT

The disclosure relates to a 5G or 6G communication system for supporting a higher data transmission rate. The present disclosure provides a method performed by a user equipment (UE) in a wireless communication system, the method comprising: receiving, from a base station associated with a serving cell, a configuration of a non-serving cell, generating a beam measurement report of the non-serving cell based on the configuration, transmitting, to the base station associated with the serving cell, the generated beam measurement report of the non-serving cell, receiving, from the base station associated with the serving cell, information on a transmission configuration indicator (TCI) state indicates TCI state of the non-serving cell, based on the beam measurement report, stopping a time alignment timer associated with the serving cell based on the information on the TCI state: and performing random access procedure on the non-serving cell based on the information on the TCI state.

### TECHNICAL FIELD

The disclosure relates to a wireless communication system. Specifically, the disclosure relates to an apparatus, a method and a system for handling UL timing alignment upon receiving TCI state update signal in a wireless communication system.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

### DISCLOSURE OF INVENTION

### Technical Problem

Recently, 3GPP has started work to enhance mobility procedures to enable L1/L2 centric inter cell mobility. UE receives from serving cell (or TRP of a serving cell), configuration of SSBs/CSI-RSs of non-serving cell (or TRP of non-serving cell) for beam measurement. Non serving cell is a neighbor cell which is not one of the serving cell within the configured cell group(s). UE performs beam measurement and report to serving cell. UE receives TCI state update (beam indication) from serving cell, indicating/activating beam of non-serving cell. UE starts receiving UE-dedicated PDSCH, PDCCH from non-serving cell. UE starts transmitting UE-dedicated PUSCH, and PUCCH from non-serving cell. Note that the serving cell and non-serving cell have different physical cell identity (PCI). Non-serving cell can also be referred as a TRP with different PCI than the PCI of serving cell. Serving cell (Cell1) and non-Serving cell (2) belongs to same DU. So UE continue to use the same MAC entity for transmitting/receiving to/from the non-serving cell, MAC entity is not reset. The issue is how to handle to handle UL timing/timeAlignmentTimer after the UE receives TCI state update (beam indication) from serving cell, indicating/activating beam of non-serving cell.

### Solution to Problem

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G).

In accordance with an aspect of the disclosure, a method performed by a user equipment (UE) in a wireless communication system, the method comprising: receiving, from a base station associated with a serving cell, a configuration of a non-serving cell, generating a beam measurement report of the non-serving cell based on the configuration, transmitting, to the base station associated with the serving cell, the generated beam measurement report of the non-serving cell, receiving, from the base station associated with the serving cell, information on a transmission configuration indicator (TCI) state indicates TCI state of the non-serving cell, based on the beam measurement report, stopping a time alignment timer associated with the serving cell based on the information on the TCI state, and performing random access procedure on the non-serving cell based on the information on the TCI state.

In accordance with another aspect of the disclosure, a method performed by a base station associated with a serving cell in a wireless communication system, the method comprising: transmitting, to a user equipment (UE), a configuration of a non-serving cell, receiving, from the UE, a beam measurement report of the non-serving cell based on the configuration of the non-serving cell, identifying a transmission configuration indicator (TCI) state of the non-serving cell based on the received beam measurement report; and transmitting, to the UE, information on the identified TCI state of the non-serving cell, wherein the information on the TCI state of the non-serving cell indicates the UE to stop a time alignment timer associated with the serving cell.

In accordance with another aspect of the disclosure, a user equipment (UE) in a wireless communication system, the UE comprising: at least one transceiver; and at least one processor operably coupled with the at least one transceiver, wherein the at least one processor is configured to: receive, from a base station associated with a serving cell, a configuration of a non-serving cell; generate a beam measurement report of the non-serving cell based on the configuration; transmit, to the base station associated with the serving cell, the generated beam measurement report of the non-serving cell; receive, from the base station associated with the serving cell, information on a transmission configuration indicator (TCI) state indicates TCI state of the non-serving cell, based on the beam measurement report; stop a time alignment timer associated with the serving cell based on the information on the TCI state; and perform random access procedure on the non-serving cell based on the information on the TCI state.

In accordance with another aspect of the disclosure, a base station (BS) associated with a serving cell in a wireless communication system, the BS comprising: at least one transceiver; and at least one processor operably coupled with the at least one transceiver, wherein the at least one processor is configured to: transmit, to a user equipment (UE), a configuration of a non-serving cell; receive, from the UE, a beam measurement report of the non-serving cell based on the configuration of the non-serving cell; identify a transmission configuration indicator (TCI) state of the non-serving cell based on the received beam measurement report; and transmit, to the UE, information on the identified TCI state of the non-serving cell, wherein the information on the TCI state of the non-serving cell indicates the UE to stop a time alignment timer associated with the serving cell.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a signaling procedures for inter-gNB handover;

FIG. 2 illustrates a UE operation upon receiving the TCI state update/change indication activating TCI state/beam;

FIG. 3 illustrates a UE operation checking whether the cell is serving cell or non-serving cell;

FIG. 4 illustrates a signaling procedures between a UE and a gNB for handling UL timing alignment;

FIG. 5 illustrates an another signaling procedures between a UE and a gNB for handling UL timing alignment;

FIG. 6 illustrates an another signaling procedures between a UE and a gNB for handling UL timing alignment;

FIG. 7 illustrates a block diagram illustrating a structure of a UE according to an embodiment of the disclosure; and

FIG. 8 illustrates a block diagram illustrating a structure of a base station (BS) according to an embodiment of the disclosure.

Throughout the drawings, like reference numerals will be understood to refer to like parts, components, and structures.

### BEST MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

### MODE FOR THE INVENTION

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases the fifth generation wireless communication system wireless system is expected to address is enhanced Mobile Broadband (cMBB), massive Machine Type Communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

Embodiments of the present disclosure are described based on 3GPP communication system (e.g., an LTE communication system or an NR communication system), but the contents of the present disclosure are not limited thereto and may be applied in various wireless communication systems for transmitting uplink control information.

The term ‘base station’ may be referred as the ‘access point (AP)’, ‘eNodeB (eNodeB)’, ‘5G node (5th generation node)’, ‘5G node ratio (5G NodeB, NB)’, ‘ next generation node B (gNB)’, ‘wireless point’, ‘transmission/reception point (TRP)’, ‘distributed unit (DU)’, ‘wireless unit’ (radio unit, RU), remote radio equipment (remote radio head, RRH), or may be referred to as another term having an equivalent technical meaning. According to various embodiments, the base station may be connected to one or more ‘transmission/reception points (TRP)’. The base station may transmit a downlink signal to the terminal 120 or receive an uplink signal through one or more TRPs. In one embodiments, the base station comprises at least one transceiver and at least one processor to perform operations described below.

The base station may be implemented to form an access network having an integrated deployment (eg, an eNB of LTE), as well as a distributed deployment. In some embodiments, the base station is divided into a central unit (CU) and a digital unit (DU), and the CU is associated with an upper layer function (eg, packet data Convergence protocol (PDCP), radio resource control (RRC)). DU is associated with lower layers (eg, radio link control (RLC), medium access control (MAC), physical (PHY)). In this way, the base station having the distributed deployment may further include a configuration for fronthaul interface (i.e., F1 interface) communication. According to an embodiment, the base station, as a DU, may perform functions for transmitting and receiving signals in a wired communication environment. The DU may include a wired interface for controlling a direct connection between the device and the device via a transmission medium (eg, copper wire, optical fiber). For example, the DU may transmit an electrical signal to another device through a copper wire or perform conversion between an electrical signal and an optical signal. One or more DUs may be connected to a CU in a distributed deployment. However, this description is not to be construed as excluding a scenario in which the DU is connected to the CU through a wireless network. In addition, the DU may be additionally connected to a radio unit (RU). However, this description is not to be construed as excluding a radio environment consisting only of CUs and DUs.

The terminal is a device used by a user and performs communication with the base station through a wireless channel. The terminal may be referred as includes ‘user equipment (UE)’, ‘mobile station’, ‘subscriber station’, ‘customer premises equipment’ (CPE), ‘remote terminal’, ‘wireless terminal’, ‘electronic device’, or ‘vehicle (vehicle) terminal’, ‘user device’ or equivalent technical other than a terminal. The terminal may be referred to by other terms that have meaning. In one embodiments, the terminal comprises at least one transceiver and at least one processor to perform operations described below.

Hereinafter, in the present disclosure, higher layer signaling or higher signal refers to signal transmitted from the base station to the terminal using the downlink data channel of the physical layer, or from the terminal to the base station using the uplink data channel of the physical layer. According to an embodiment, the higher layer signaling comprises radio resource control (RRC) signaling, or signaling according to the F1 interface between a centralized unit (CU) and a distributed unit (DU), or a media access control (MAC) control element (CE) (MAC CE). Also, according to an embodiment, the higher layer signaling or the higher signal may include system information commonly transmitted (i.e.g, broadcasted) to a one or more UEs, for example, a system information block (SIB).

CA/Multi-connectivity in fifth generation wireless communication system: The fifth generation wireless communication system, supports standalone mode of operation as well dual connectivity (DC). In DC a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilise radio resources provided by two distinct schedulers, located in two different nodes connected via a non-ideal backhaul and providing either E-UTRA (i.e. if the node is an ng-eNB) or NR access (i.e. if the node is a gNB). In NR for a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the PCell and optionally one or more SCells. In NR the term Secondary Cell Group (SCG) refers to a group of serving cells associated with the Secondary Node, comprising of the PSCell and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

System information acquisition in fifth generation wireless communication system is described in the description below. In the fifth generation wireless communication system, node B (gNB) or base station in cell broadcast Synchronization Signal and PBCH block (SSB) consists of primary and secondary synchronization signals (PSS, SSS) and system information. System information includes common parameters needed to communicate in cell. In the fifth generation wireless communication system (also referred as next generation radio or NR), System Information (SI) is divided into the MIB and a number of SIBs where:

The MIB is always transmitted on the BCH with a periodicity of 80 ms and repctitions made within 80 ms and it includes parameters that are needed to acquire SIB1 from the cell.

The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, SIB1 repetition transmission period is 20 ms. For SSB and CORESET multiplexing pattern 2/3, SIB1 transmission repetition period is the same as the SSB period. SIB1 includes information regarding the availability and scheduling (e.g. mapping of SIBs to SI message, periodicity, SI-window size) of other SIBs with an indication whether one or more SIBs are only provided on-demand and, in that case, the configuration needed by the UE to perform the SI request. SIB1 is cell-specific SIB.

SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message.

For a UE in RRC_CONNECTED, the network can provide system information through dedicated signaling using the RRCReconfiguration message, e.g. if the UE has an active BWP with no common search space configured to monitor system information, paging, or upon request from the UE. In RRC_CONNECTED, UE needs to acquire the required SIB(s) only from PCell.

For PSCell and SCells, the network provides the required SI by dedicated signaling, i.e. within an RRCReconfiguration message. Nevertheless, the UE shall acquire MIB of the PSCell to get SFN timing of the SCG (which may be different from MCG). Upon change of relevant SI for SCell, the network releases and adds the concerned SCell. For PSCell, the required SI can only be changed with Reconfiguration with Sync.

UEs in RRC_IDLE or in RRC_INACTIVE shall monitor for SI change indication on camped cell (or PCell) in its own paging occasion every DRX cycle. UEs in RRC_CONNECTED shall monitor for SI change indication on PCell in any paging occasion at least once per modification period if the UE is provided with common search space, including pagingScarchSpace, searchSpaceSIB1 and searchSpaceOtherSystemInformation, on the active BWP of PCell to monitor paging.

ETWS or CMAS capable UEs in RRC_IDLE or in RRC_INACTIVE shall monitor for indications about PWS notification on camped cell (or PCell) in its own paging occasion every DRX cycle. ETWS or CMAS capable UEs in RRC_CONNECTED shall monitor for indication about PWS notification on PCell in any paging occasion at least once every defaultPagingCycle if the UE is provided with common search space, including pagingSearchSpace, searchSpaceSIB1 and searchSpaceOtherSystemInformation, on the active BWP of PCell to monitor paging.

Random access in fifth generation wireless communication system: In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state. Several types of random access procedure is supported such as contention based random access, contention free random access and each of these can be one 2 step or 4 step random access.

From the physical layer perspective, the Type-1 L1 random access procedure (4 step random access) includes the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

From the physical layer perspective, the Type-2 L1 random access procedure (2 step random access) includes the transmission of random access preamble in a PRACH and of a PUSCH (MsgA) and the reception of a RAR message with a PDCCH/PDSCH (MsgB), and when applicable, the transmission of a PUSCH scheduled by a fallback RAR UL grant, and PDSCH for contention resolution.

PDCCH in fifth generation wireless communication system is described in the description below. In the fifth generation wireless communication system, Physical Downlink Control Channel (PDCCH) is used to schedule DL transmissions on physical downlink shared channel (PDSCH) and UL transmissions on PUSCH, where the Downlink Control Information (DCI) on PDCCH includes: Downlink assignments containing at least modulation and coding format, resource allocation, and hybrid-ARQ information related to DL-SCH; Uplink scheduling grants containing at least modulation and coding format, resource allocation, and hybrid-ARQ information related to UL-SCH. In addition to scheduling, PDCCH can be used to for at least one of Activation and deactivation of configured PUSCH transmission with configured grant; Activation and deactivation of PDSCH semi-persistent transmission; Notifying one or more UEs of the slot format; Notifying one or more UEs of the PRB(s) and OFDM symbol(s) where the UE may assume no transmission is intended for the UE; Transmission of TPC commands for PUCCH and PUSCH; Transmission of one or more TPC commands for SRS transmissions by one or more UEs; Switching a UE's active bandwidth part; or Initiating a random access procedure. A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In fifth generation wireless communication system, a list of search space configurations is signaled by GNB for each configured BWP of serving cell wherein each search configuration is uniquely identified by a search space identifier. Search space identifier is unique amongst the BWPs of a serving cell. Identifier of search space configuration to be used for specific purpose such as paging reception, SI reception, random access response reception is explicitly signaled by gNB for each configured BWP. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

$$( y * ( number of slots in a radio frame ) + x - Monitoring - offset - PDCCH - slot ) mod ( Monitoring - periodicity - PDCCH - slot ) = 0$$

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space, search space configuration includes the identifier of coreset configuration associated with it. A list of coreset configurations are signaled by GNB for each configured BWP of serving cell wherein each coreset configuration is uniquely identified by an coreset identifier. Coreset identifier is unique amongst the BWPs of a serving cell. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each coreset configuration is associated with a list of TCI (Transmission configuration indicator) states. One DL RS ID (SSB or CSI RS) is configured per TCI state. The list of TCI states corresponding to a coreset configuration is signaled by gNB via RRC signaling. One of the TCI state in TCI state list is activated and indicated to UE by gNB. TCI state indicates the DL TX beam (DL TX beam is QCLed with SSB/CSI RS of TCI state) used by GNB for transmission of PDCCH in the PDCCH monitoring occasions of a search space.

In this specification, the term ‘beam’ refers to a spatial flow of a signal in a radio channel, and is formed by one or more antennas (or antenna elements), and this formation process may be referred to as beamforming. In some embodiments, an antenna array in which a plurality of antenna elements are concentrated may be used, and in this case, a shape (i.e., coverage) according to a signal gain may have a direction. A beam used for transmission of a signal may be referred to as a transmission beam or a beam used for reception of a signal may be referred to as a reception beam.

When a device (e.g., base station or terminal) transmits a signal in the direction of a transmission beam, the signal gain of the device may increase. When a signal is transmitted using a transmission beam, a signal may be transmitted through a spatial domain transmission filter of a side that transmits the signal, that is, a transmission end. When transmitting a signal using a plurality of transmission beams, the transmitting end may transmit the signal while changing a spatial domain transmission filter. For example, when transmitting using the same transmission beam, the transmitting end may transmit a signal through the same spatial domain transmission filter. For example, when the UE receives CSI-RSs for reception beam discovery (e.g., 3GPP TS 38.214 repetition=‘on’), the UE has the same (same) spatial domain transmission filter (spatial)).

When a device (e.g., base station or terminal) receives a signal in the direction of a reception beam, the signal gain of the device may increase. When a signal is transported using a reception beam, a signal may be received through a side receiving the signal, that is, a spatial domain reception filter of the receiving end. For example, when the terminal simultaneously receives multiple signals transmitted using different beams, the terminal receives the signals using a single spatial domain receive filter or multiple simultaneous spatial domains. The signals may be received using multiple simultaneous spatial domain receive filters.

In addition, as a signal transmitted using the beam in the present disclosure, a reference signal may be used, for example, a demodulation-reference signal (DM-RS), a channel state information-reference signal (CSI-RS), The signal may include a synchronization signal/physical broadcast channel (SS/PBCH) and a sounding reference signal (SRS). In addition, as a configuration for each reference signal, an IE such as a CSI-RS resource or an SRS-resource may be used, and this configuration may include information associated with a beam. The information related to the beam is whether the configuration (e.g., CSI-RS resource) uses the same spatial domain filter as the other configuration (e.g., another CSI-RS resource in the same CSI-RS resource set) or is different. It may mean whether a spatial domain filter is used, or which reference signal is quasi-co-located (QCL), and if it is QCL, which type (eg, QCL type A, B, C, D). The QCL type may be defined as follows.

According to various embodiments, the QCL type and the associated reference resource (e.g., CSI-RS resource or SSB resource) are configured as ‘TCI state’. The TCI state associates reference signals with a corresponding quasi-colocation (QCL) type.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The terminal may measure the quality of the beam in order to measurements (e.g., the cell quality or the BWP quality). The UE may obtain the beam quality based on the CSI-RS or SS/PBCH block.

BWP operation in fifth generation wireless communication system is described in the description below. In fifth generation wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

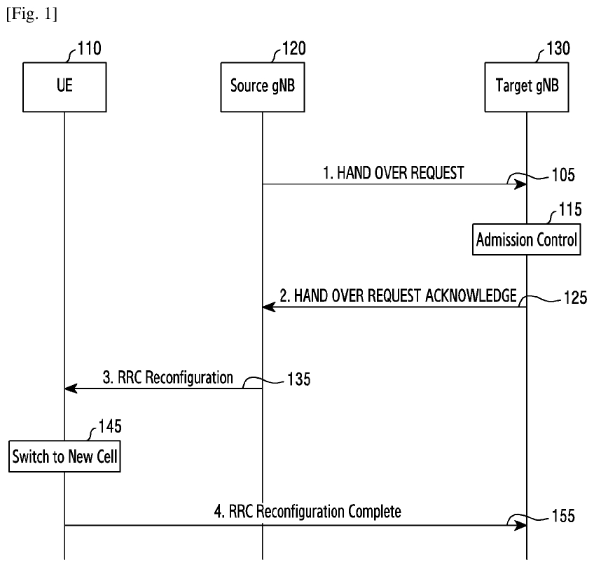

FIG. 1 illustrates a signaling procedures for inter-gNB handover.

Referring to FIG. 1, mobility in in fifth generation wireless communication system may have various types. There are two types of mobility, cell level mobility and beam level mobility. Cell Level Mobility requires explicit RRC signaling to be triggered, i.e. handover. For inter-gNB handover, the signaling procedures consist of at least the following elemental components as shown in FIG. 1.

In step 105, a source gNB 120 transmits handover request message to a target gNB 130. The source gNB 120 initiates handover and issues a HANDOVER REQUEST 105 over the Xn interface.

In step 115, the target gNB 130 performs admission control 115,

In step 125, the target gNB 130 provides the new RRC configuration as part of the HANDOVER REQUEST ACKNOWLEDGE 125.

In step 135, the source gNB 120 provides the RRC configuration 135 to the UE 110 by forwarding the RRCReconfiguration message received in the HANDOVER REQUEST ACKNOWLEDGE. The RRCReconfiguration message 135 includes at least cell ID and all information required to access the target cell so that the UE 110 can access the target cell without reading system information. For some cases, the information required for contention-based and contention-free random access can be included in the RRCReconfiguration message. The access information to the target cell may include beam specific information, if any.

In step 145, the UE switches to new cell (target gNB) based on the received RRC reconfiguration.

In step 155, the UE 110 moves the RRC connection 145 to the target gNB 130 and replies with the RRCReconfigurationComplete 155. Several types of handover, normal handover, conditional handover and DAPS handover are supported.

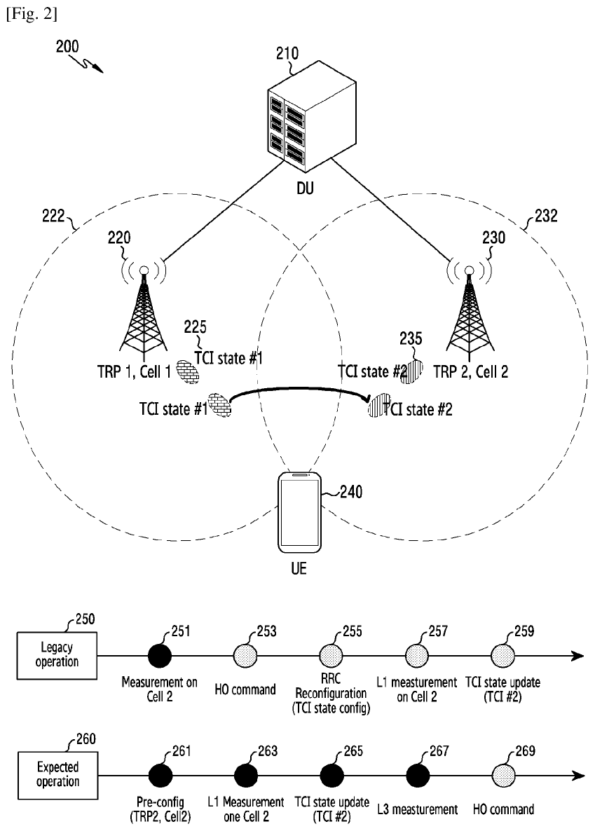

FIG. 2 illustrates a UE operation upon receiving the TCI state update/change indication activating TCI state/beam.

Beam Level Mobility does not require explicit RRC signaling to be triggered. The gNB provides for serving cell via RRC signaling the UE with measurement configuration containing configurations of SSB/CSI resources and resource sets, reports and trigger states for triggering channel and interference measurements and reports. Beam Level Mobility is then dealt with at lower layers by means of physical layer and MAC layer control signaling, and RRC is not required to know which beam is being used at a given point in time. Based on physical layer and MAC layer control signaling UE can be switched from one beam to another in serving cell.

FeMIMO (further enhanced MIMO) WI (working item) aims to enable L1/L2 centric inter cell mobility.

Referring to FIG. 2, UE 240 receives from serving cell 220, configuration of SSBs/CSI-RSs of non serving cell 230 for beam measurement. UE 240 performs beam measurement and report to serving cell 220. UE 240 receives TCI state update (beam indication) from serving cell 220, indicating/activating beam of non serving cell 230. UE 240 starts receiving UE-dedicated PDSCH, PDCCH from non serving cell 230. UE 240 starts transmitting UE-dedicated PUSCH, and PUCCH to the non serving cell 230.

Referring to FIG. 2, Serving cell and non serving cell have different physical cell identity (PCI).

Subsequently HO (handover) 269 may/may not be triggered based on L3 measurement 267.

Recently, 3GPP has started work to enhance mobility procedures to enable L1/L2 centric inter cell mobility. UE 240 receives from serving cell (or TRP of a serving cell) 220, configuration of SSBs/CSI-RSs of non-serving cell (or TRP of non-serving cell) 230 for beam measurement 261. Non serving cell 230 is a neighbor cell which is not one of the serving cell 220 within the configured cell group(s). UE 240 performs beam measurement 263 and report to serving cell. UE 240 receives TCI state update (beam indication) 265 from serving cell 220, indicating/activating beam of non-serving cell 230. UE 240 starts receiving UE-dedicated PDSCH, PDCCH from non-serving cell. UE starts transmitting UE-dedicated PUSCH, and PUCCH to the non-serving cell 230. Note that the serving cell 220 and non-serving cell 230 have different physical cell identity (PCI). Non-serving cell 230 can also be referred as a TRP with different PCI than the PCI of serving cell. FIG. 2 is illustration of this operation. Serving cell (Cell1) 220 and non-Serving cell (2) 230 belongs to same DU 210. So UE 240 continue to use the same MAC entity for transmitting/receiving to/from the non-serving cell 230, MAC entity is not reset. The issue is how to handle UL timing/timeAlignmentTimer after the UE receives TCI state update (beam indication) from serving cell (or from TRP of a serving cell), indicating/activating beam of non-serving cell (or to another TRP of serving cell with different PCI then PCI of serving cell). In the disclosure, ‘Serving Cell’ can also be referred as a TRP of serving cell with same PCI as serving cell. Non Serving cell can be referred as a TRP of serving cell with different PCI then PCI of serving cell. Non Serving cell can also be referred as auxiliary cell.

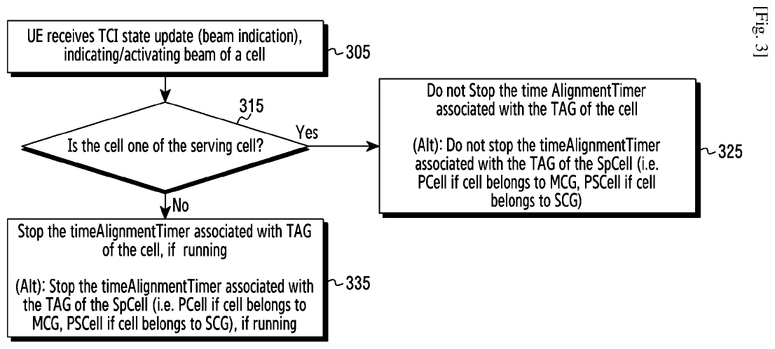

FIG. 3 illustrates a UE operation checking whether the cell is serving cell or non-serving cell.

Referring to FIG. 3, in step 305, UE receives TCI state update (beam indication) from serving cell, indicating/activating beam of non-serving cell.

In one embodiment of this disclosure, UE operation upon receiving the TCI state update/change indication activating TCI state/beam is illustrated in FIG. 2.

In step 315, upon receiving TCI state update/change indication activating TCI state/beam for a cell, UE checks whether the cell is serving cell or non-serving cell:

If the cell is non serving cell, it proceeds to step 335.

In step 325, the UE may perform at least one of options describes below.

Option 1: UE stops the timeAlignmentTimer associated with TAG (timing advanced group) of the non-serving cell, if running. TAG of the non-serving cell is indicated in configuration of the non-serving cell received from gNB.

Option 2: If the TCI state update/change indication of non-serving cell is restricted to SpCell or PTAG (primary TAG): UE stops the timeAlignmentTimer associated with PTAG, if running.

Option 3: UE stops the timeAlignmentTimer (if running) associated with TAG of the non-serving cell, if the TAG of the non-serving cell is PTAG. TAG of the non-serving cell is indicated in configuration of the non-serving cell received from gNB.

UE then initiate random access procedure. Alternately, upon receiving PDCCH order, UE initiate random access procedure.

If the cell is serving cell, it proceeds to step 325.

In step 325, time AlignmentTimer associated with TAG of cell is not stopped.

Alternatively, UE does not stop the time AlignmentTimer associated with the TAG of the SpCell (e.g PCell if cell belongs to MCG or PSCell if cell belongs to SCG).

In the above operation, non-serving cell can also be referred as a TRP with different PCI than the PCI of serving cell (or PCI of TRP of serving cell).

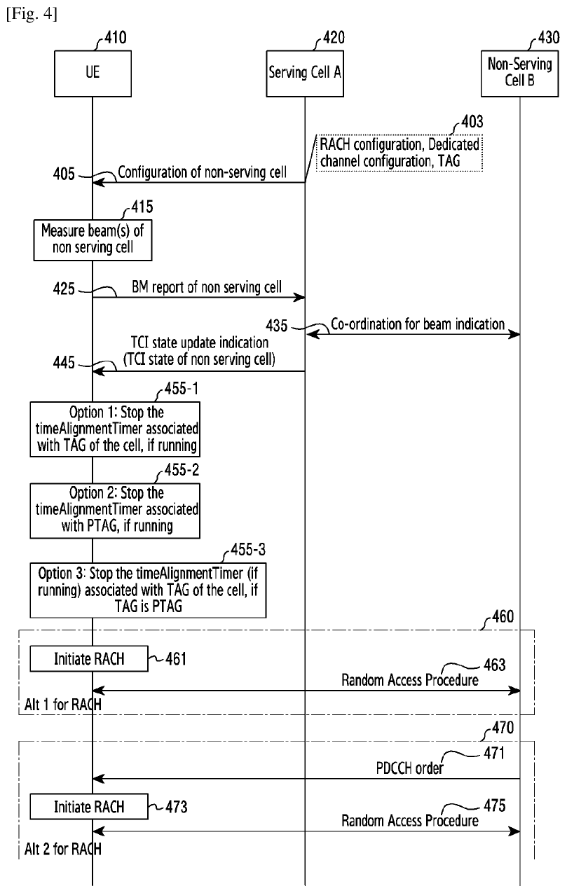

FIG. 4 illustrates a signaling procedures between a UE and a gNB for handling UL timing alignment.

In one embodiment of this disclosure the signaling between UE and gNB is illustrated in FIG. 4.

Referring to FIG. 4, in step 405, UE 410 receives from serving cell (e.g. PCell) 420, configuration of non-serving cell 430. Note that configuration can be received for multiple non-serving cells. A non-serving cell is associated with one of serving cell. In an embodiment, associated serving cell of non-serving cell can always be the SpCell. In an embodiment associated serving cell of non-serving cell can be SCell or SpCell. This association can be signaled in configuration. The association can be implicit by including non-serving configuration in serving cell configuration of associated serving cell. RRCReconfiguration message can be used for configuration. Non serving cell is a neighbor cell which is not one of the serving cell within the configured cell group(s). Configuration of non-serving cell includes beam measurement configuration such as SSBs/CSI-RSs to measure, time and frequency resources of SSBs/CSI-RSs, quantity to measure and report, number of SSBs/CSI-RSs to report, QCL information of SSBs/CSI-RSs with respect to SSBs/CSI-RSs in serving cell (e.g. signaling can indicate which SSB/CSI-RS of non-serving cell is QCLed with which SSB/CSI-RS of serving cell and which serving cell), threshold for reporting a SSB/CSI-RS in report, reporting type (e.g. periodic, period of reporting if periodic) etc. Configuration of non-serving cell includes paging search configuration (e.g. search space and corset to measure) for monitoring PDCCH for paging in non-serving cell. Configuration includes system information search configuration (e.g. search space and corset to measure, searchSpaceSIB1, searchSpaceOtherSystemInformation) for monitoring PDCCH for paging in non-serving cell. Configuration of non-serving cell includes RACH configuration (e.g. rar search space and corset to measure, RACH resources (preambles config, rach occasion config, etc.) and parameters) for performing RA in non-serving cell. Configuration of non-serving cell may include configuration of one or more BWPs of non-serving cell. Configuration of non-serving cell may indicate which BWP of non-serving cell should be activated upon reception of TCI state update indication activating TCI state of non-serving cell; if not indicated the BWP with BWP id of active BWP on serving cell is activated on non-serving cell. Configuration of non-serving cell may include C-RNTI, CS-RNTI to be used in non-serving cell; if not included UE continue to use C-RNTI, CS-RNTI of serving cell in non-serving cell upon activation of TCI state of non-serving cell. Configuration of non-serving cell may indicate whether to perform RACH or not upon activation of TCI state of non-serving cell.

In step 415, UE 410 performs measurement of SSBs/CSI-RSs of non-serving cell as per the received configuration.

In step 425, UE 410 reports the performed beam measurement to serving cell 420.

In step 435, serving cell 420 coordinates with non-serving cell 430 and determines whether to activate TCI state of non-serving cell or not. Serving cell 420 may indicate one or more TCI states of non-serving cell which can be activated based on report from UE 410 or alternately serving cell 420 can send the report to non-serving cell 430 and non-serving cell 430 indicates the TCI state to be activated to serving cell 410. In an alternate embodiment, determination of TCI state of non-serving cell to be activated can be taken by serving cell 420 itself based on report from UE 410.

In step 445, serving cell 420 indicates to UE 410 the TCI state of non-serving cell to be activated. The indication can be via PDCCH or MAC CE. MAC CE may include one or more of TCI state ID, corset ID, cell identification.

Upon receiving the TCI state update indication activating TCI state/beam of non serving cell, the UE 410 may perform at least one of the following options:

In step 455-1, Option 1: UE 410 stops the timeAlignmentTimer associated with TAG (timing advanced group) of the non-serving cell, if running. TAG of the non-serving cell is indicated in configuration of the non-serving cell received from gNB.

In step 455-2, Option 2: If the TCI state update/change indication of non-serving cell is restricted to SpCell or PTAG (primary TAG), UE 410 stops the timeAlignmentTimer associated with PTAG, if running.

In step 455-3, Option 3: UE 410 stops the timeAlignmentTimer (if running) associated with TAG of the non-serving cell, if the TAG of the non-serving cell is PTAG. TAG of the non-serving cell is indicated in configuration of the non-serving cell received from gNB

In step 460, UE 410 then initiate random access procedure 463.

In step 470, alternately, upon receiving PDCCH order 471, UE 410 initiate random access procedure 475.

In an embodiment of this disclosure, upon receiving TCI state update/change indication activating TCI state/beam of a TRP having PCI X wherein PCI X is different from PCI of any serving cell, the UE 410 may perform at least one of the following options:

In step 455-1, Option 1: UE 410 stops the timeAlignmentTimer associated with TAG (timing advanced group) of the TRP or cell with PCI X, if running. TAG of the TRP or cell with PCI X is indicated in configuration received from gNB.

In step 455-2, Option 2: UE 410 stops the timeAlignmentTimer associated with PTAG, if running.

In step 455-3, Option 3: UE 410 stops the timeAlignmentTimer (if running) associated with TAG of the TRP or cell with PCI X, if the TAG of the TRP or cell with PCI X is PTAG. TAG of the TRP or cell with PCI X is indicated in configuration received from gNB.

In step 460, UE 410 then initiate random access procedure 463.

In step 470, alternately, upon receiving PDCCH order 471, UE 410 initiate random access procedure 475.

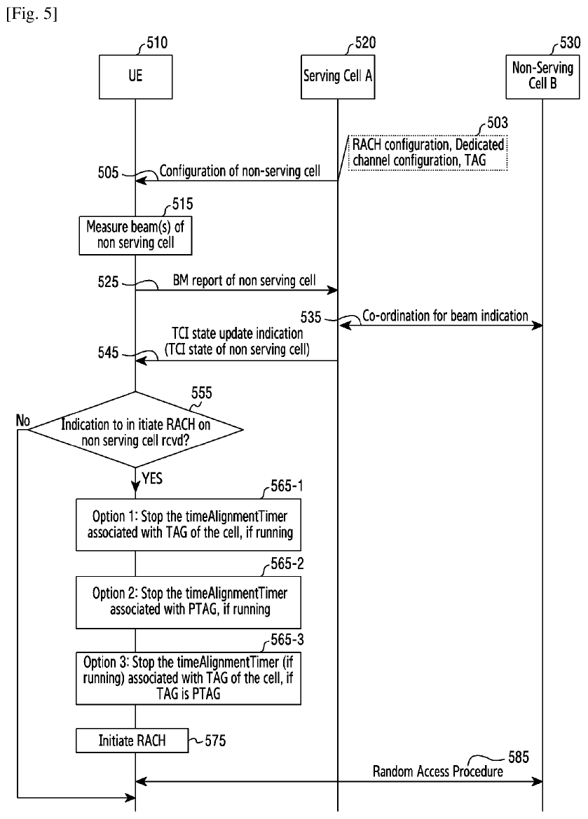

FIG. 5 illustrates an another signaling procedures between a UE and a gNB for handling UL timing alignment.

Referring to FIG. 5, in step 505, UE 510 receives from serving cell (e.g. PCell) 520, configuration of non-serving cell 530. Note that configuration can be received for multiple non-serving cells. Step 505 may be substantially the same as step 405 of FIG. 4.

In step 515, UE 510 performs measurement of SSBs/CSI-RSs of non-serving cell as per the received configuration. Step 515 may be substantially the same as step 415 of FIG. 4.

In step 525, UE 510 report the performed beam measurement to serving cell 520. Step 525 may be substantially the same as step 425 of FIG. 4.

In step 535, serving cell 520 coordinates with non-serving cell 530 and determines whether to activate TCI state of non-serving cell 530 or not. Serving cell 520 may indicate one or more TCI states of non-serving cell which can be activated based on report from UE 510 or alternately serving cell 520 can send the report to non-serving cell 530 and non-serving cell 530 indicates the TCI state to be activated to serving cell. In an alternate embodiment, determination of TCI state of non-serving cell 530 to be activated can be taken by serving cell 520 itself based on report from UE 510. Step 535 may be substantially the same as step 435 of FIG. 4.

In step 545, serving cell 520 indicates to UE 510 the TCI state of non-serving cell 530 to be activated. The indication can be via PDCCH or MAC CE. MAC CE may include one or more of TCI state ID, corset ID, cell identification. Step 545 may be substantially the same as step 445 of FIG. 4.

In one embodiment of this disclosure, in step 555, upon receiving TCI state update/change indication activating TCI state/beam for a cell, UE 510 checks whether the cell is serving cell 520 or non-serving cell 530.

If the cell is non serving cell, it proceeds to at least one of step 565-1, step 565-2 or step 565-3.

In step 555, UE 510 checks whether gNB has indicated in L1/L2 signal used for TCI state update/change indication, and TCI state update/change indication may include at least one of:
A) indication to initiate random access procedure on non serving cell; or
B) indication to stop timeAlignmentTimer

If A) or B) is received, the UE 510 may perform at least one of the following steps:

In step 565-1, Option 1: UE 510 stops the timeAlignmentTimer associated with TAG (timing advanced group) of the non-serving cell, if running. TAG of the non-serving cell is indicated in configuration of the non-serving cell received from gNB.

In step 565-2, Option 2: If the TCI state update indication of non serving cell is restricted to SpCell or PTAG, UE 510 stops the timeAlignmentTimer associated with PTAG, if running.

In step 565-3, Option 3: UE 510 stops the timeAlignmentTimer (if running) associated with TAG of the non-serving cell, if the TAG of the non-serving cell is PTAG. TAG of the non-serving cell is indicated in configuration of the non-serving cell received from gNB.

In step 575, and step 585, the UE 510 may initiate a random access procedure.

In case that the TCI state update/change indication includes A), UE 510 also initiate random access procedure on non serving cell. In this case, it may be substantially the same as step 460 of FIG. 4.

In case that the TCI state update/change indication include B), gNB can send PDCCH order to initiate random access procedure, upon receiving PDCCH order UE initiate random access procedure. In this case, it may be substantially the same as step 470 of FIG. 4.

If the cell is serving cell, timeAlignmentTimer associated with TAG of cell is not stopped.

In the above operation, non-serving cell can also be referred as a TRP with different PCI than the PCI of serving cell (or PCI of TRP of serving cell).

In one embodiment of this disclosure the signaling between UE and gNB is illustrated in FIG. 5.

Referring to FIG. 5, in step 505, UE 510 receives from serving cell (e.g. PCell) 520, configuration of non-serving cell 530. Note that configuration can be received for multiple non-serving cells. A non-serving cell is associated with one of serving cell. In an embodiment, associated serving cell of non-serving cell can always be the SpCell. In an embodiment associated serving cell of non-serving cell can be SCell or SpCell. This association can be signaled in configuration. The association can be implicit by including non-serving configuration in serving cell configuration of associated serving cell. RRCReconfiguration message can be used for configuration. Non serving cell is a neighbor cell which is not one of the serving cell within the configured cell group(s). Configuration of non-serving cell includes beam measurement configuration such as SSBs/CSI-RSs to measure, time and frequency resources of SSBs/CSI-RSs, quantity to measure and report, number of SSBs/CSI-RSs to report, QCL information of SSBs/CSI-RSs with respect to SSBs/CSI-RSs in serving cell (e.g. signaling can indicate which SSB/CSI-RS of non-serving cell is QCLed with which SSB/CSI-RS of serving cell and which serving cell), threshold for reporting a SSB/CSI-RS in report, reporting type (e.g. periodic, period of reporting if periodic) etc. Configuration of non-serving cell includes paging search configuration (e.g. search space and corset to measure) for monitoring PDCCH for paging in non-serving cell. Configuration includes system information search configuration (e.g. search space and corset to measure, searchSpaceSIB1, searchSpaceOtherSystemInformation) for monitoring PDCCH for paging in non-serving cell. Configuration of non-serving cell includes RACH configuration (e.g. rar search space and corset to measure, RACH resources (preambles config, rach occasion config, etc.) and parameters) for performing RA in non-serving cell. Configuration of non-serving cell may include configuration of one or more BWPs of non-serving cell. Configuration of non-serving cell may indicate which BWP of non-serving cell should be activated upon reception of TCI state update indication activating TCI state of non-serving cell; if not indicated the BWP with BWP id of active BWP on serving cell is activated on non-serving cell. Configuration of non-serving cell may include C-RNTI, CS-RNTI to be used in non-serving cell; if not included UE continue to use C-RNTI, CS-RNTI of serving cell in non-serving cell upon activation of TCI state of non-serving cell. Configuration of non-serving cell may indicate whether to perform RACH or not upon activation of TCI state of non-serving cell.

In step 515, UE 510 performs measurement of SSBs/CSI-RSs of non-serving cell as per the received configuration.

In step 525, UE 510 reports the performed beam measurement to serving cell 520.

In step 535, the serving cell 520 coordinates with non-serving cell 530 and determines whether to activate TCI state of non-serving cell or not. Serving cell 520 may indicate one or more TCI states of non-serving cell which can be activated based on report from UE 510 or alternately serving cell 520 can send the report to non-serving cell 530 and non-serving cell 530 indicates the TCI state to be activated to serving cell 510. In an alternate embodiment, determination of TCI state of non-serving cell to be activated can be taken by serving cell 520 itself based on report from UE 510.

In step 545, serving cell 520 indicates to UE 510 the TCI state of non-serving cell to be activated. The indication can be via PDCCH or MAC CE. MAC CE may include one or more of TCI state ID, corset ID, cell identification.

In step 555, upon receiving the TCI state update indication activating TCI state/beam of non-serving cell, UE 510 checks whether gNB has indicated in L1/L2 signal used for TCI state update/change indication, and TCI state update/change indication may include at least one of:
A) indication to initiate random access procedure on non serving cell or
B) indication to stop timeAlignmentTimer

If A) or B) is received, the UE 510 may perform at least one of the following steps:

In step 565-1, Option 1: UE 510 stops the timeAlignmentTimer associated with TAG (timing advanced group) of the non-serving cell, if running. TAG of the non-serving cell is indicated in configuration of the non-serving cell received from gNB.

In step 565-2, Option 2: If the TCI state update indication of non-serving cell is restricted to SpCell or PTAG, UE 510 stops the timeAlignmentTimer associated with PTAG, if running.

In step 565-3, Option 3: UE 510 stops the timeAlignmentTimer (if running) associated with TAG of the non-serving cell, if the TAG of the non-serving cell is PTAG. TAG of the non-serving cell is indicated in configuration of the non-serving cell received from gNB.

In step 575, and step 585, the UE 510 may initiate a random access procedure.

In case that the TCI state update/change indication includes A), UE 510 also initiate random access procedure on non serving cell. In this case, it may be substantially the same as step 460 of FIG. 4.

In case that the TCI state update/change indication include B), gNB can send PDCCH order to initiate random access procedure. Upon receiving PDCCH order, UE initiate random access procedure. In this case, it may be substantially the same as step 470 of FIG. 4.

In an embodiment of this disclosure, in step 555, upon receiving TCI state update/change indication activating TCI state/beam of a TRP having PCI X wherein PCI X is different from PCI of any serving cell, UE 510 checks whether gNB has indicated in L1/L2 signal used for TCI state update/change indication, and TCI state update/change indication may include at least one of:
A) indication to initiate random access procedure or
B) indication to stop timeAlignmentTimer

If A) or B) is received, the UE 510 may perform at least one of the following steps:

In step 565-1, Option 1: UE 510 stops the timeAlignmentTimer associated with TAG (timing advanced group) of the TRP or cell with PCI X, if running. TAG of the TRP or cell with PCI X is indicated in configuration received from gNB.

In step 565-2, Option 2: UE 510 stops the timeAlignmentTimer associated with PTAG, if running.

In step 565-3, Option 3: UE 510 stops the timeAlignmentTimer (if running) associated with TAG of the TRP or cell with PCI X, if the TAG of the TRP or cell with PCI X is PTAG. TAG of the TRP or cell with PCI X is indicated in configuration received from gNB.

In step 575, and step 585, the UE 510 may initiate a random access procedure.

In case that the TCI state update/change indication includes A), UE also initiate random access procedure. In this case, it may be substantially the same as step 460 of FIG. 4.

In case that the TCI state update/change indication include B), gNB can send PDCCH order to initiate random access procedure, upon receiving PDCCH order UE initiate random access procedure. In this case, it may be substantially the same as step 470 of FIG. 4.

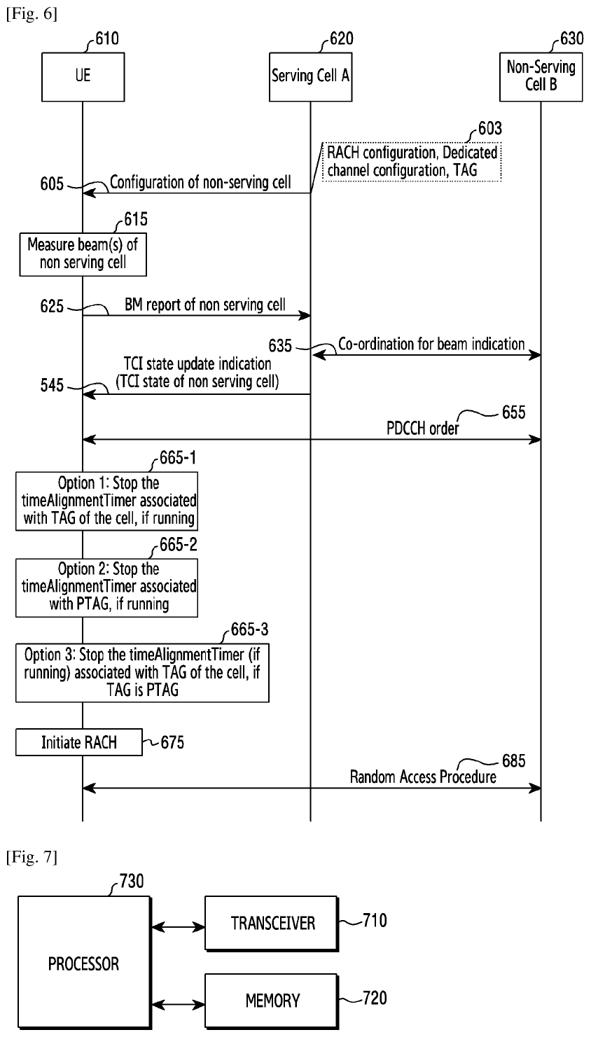

FIG. 6 illustrates an another signaling procedures between a UE and a gNB for handling UL timing alignment.

Referring to FIG. 6, in step 605, UE 610 receives from serving cell (e.g. PCell) 620, configuration of non-serving cell 630. Note that configuration can be received for multiple non-serving cells. Step 605 may be substantially the same as step 405 of FIG. 4.

In step 615, UE 610 performs measurement of SSBs/CSI-RSs of non-serving cell as per the received configuration. Step 615 may be substantially the same as step 415 of FIG. 4.

In step 625, UE 610 report the performed beam measurement to serving cell 620. Step 625 may be substantially the same as step 425 of FIG. 4.

In step 635, serving cell 620 coordinates with non-serving cell 630 and determines whether to activate TCI state of non-serving cell 630 or not. Serving cell 620 may indicate one or more TCI states of non-serving cell which can be activated based on report from UE 610 or alternately serving cell 620 can send the report to non-serving cell 630 and non-serving cell 630 indicates the TCI state to be activated to serving cell. In an alternate embodiment, determination of TCI state of non-serving cell 630 to be activated can be taken by serving cell 620 itself based on report from UE 610. Step 635 may be substantially the same as step 435 of FIG. 4.

In step 645, serving cell 620 indicates to UE 610 the TCI state of non-serving cell 630 to be activated. The indication can be via PDCCH or MAC CE. MAC CE may include one or more of TCI state ID, corset ID, cell identification. Step 645 may be substantially the same as step 445 of FIG. 4.

In one embodiment of this disclosure, although not shown in FIG. 6, upon receiving TCI state update/change indication activating TCI state/beam for a cell, UE 610 checks whether the cell is serving cell or non-serving cell. It may be substantially the same as step 555 of FIG. 5.

If the cell is non serving cell, it proceeds to at least one of step 665-1, step 665-2 or step 665-3.

In step 655, UE 610 may receive PDCCH order after/together with the TCI state update indication.

Upon receiving the first PDCCH order (for TAG of cell or for PTAG) after/together with the TCI state update indication, the UE 610 may perform at least one of the following steps:

In step 665-1, Option 1: UE 610 stops the timeAlignmentTimer associated with TAG (timing advanced group) of the non-serving cell, if running. TAG of the non-serving cell is indicated in configuration of the non-serving cell received from gNB.

In step 665-2, Option 2: If the TCI state update indication of non-serving cell is restricted to SpCell or PTAG, UE 610 stops the timeAlignmentTimer associated with PTAG, if running.

In step 665-3, Option 3: UE 610 stops the timeAlignmentTimer (if running) associated with TAG of the non-serving cell, if the TAG of the non-serving cell is PTAG. TAG of the non-serving cell is indicated in configuration of the non-serving cell received from gNB.

In step 676, and step 685, UE 610 then initiate random access procedure.

If the cell is serving cell, timeAlignmentTimer is not stopped

In one embodiment of this disclosure the signaling between UE and gNB is illustrated in FIG. 6.

Referring to FIG. 6, in step 605, UE 610 receives from serving cell (e.g. PCell) 620, configuration of non-serving cell 630. Note that configuration can be received for multiple non-serving cells. A non-serving cell is associated with one of serving cell. In an embodiment, associated serving cell of non-serving cell can always be the SpCell. In an embodiment associated serving cell of non-serving cell can be SCell or SpCell. This association can be signaled in configuration. The association can be implicit by including non-serving configuration in serving cell configuration of associated serving cell. RRCReconfiguration message can be used for configuration. Non serving cell is a neighbor cell which is not one of the serving cell within the configured cell group(s). Configuration of non-serving cell includes beam measurement configuration such as SSBs/CSI-RSs to measure, time and frequency resources of SSBs/CSI-RSs, quantity to measure and report, number of SSBs/CSI-RSs to report, QCL information of SSBs/CSI-RSs with respect to SSBs/CSI-RSs in serving cell (e.g. signaling can indicate which SSB/CSI-RS of non-serving cell is QCLed with which SSB/CSI-RS of serving cell and which serving cell), threshold for reporting a SSB/CSI-RS in report, reporting type (e.g. periodic, period of reporting if periodic) etc. Configuration of non-serving cell includes paging search configuration (e.g. search space and corset to measure) for monitoring PDCCH for paging in non-serving cell. Configuration includes system information search configuration (e.g. search space and corset to measure, searchSpaceSIB1, searchSpaceOtherSystemInformation) for monitoring PDCCH for paging in non-serving cell. Configuration of non-serving cell includes RACH configuration (e.g. rar search space and corset to measure, RACH resources (preambles config, rach occasion config, etc.) and parameters) for performing RA in non-serving cell. Configuration of non-serving cell may include configuration of one or more BWPs of non-serving cell. Configuration of non-serving cell may indicate which BWP of non-serving cell should be activated upon reception of TCI state update indication activating TCI state of non-serving cell; if not indicated the BWP with BWP id of active BWP on serving cell is activated on non-serving cell. Configuration of non-serving cell may include C-RNTI, CS-RNTI to be used in non-serving cell; if not included UE continue to use C-RNTI, CS-RNTI of serving cell in non-serving cell upon activation of TCI state of non-serving cell. Configuration of non-serving cell may indicate whether to perform RACH or not upon activation of TCI state of non-serving cell.

In step 615, UE 610 performs measurement of SSBs/CSI-RSs of non-serving cell as per the received configuration.

In step 625, UE 610 reports the performed beam measurement to serving cell 620.

In step 635, serving cell 620 coordinates with non-serving cell 630 and determines whether to activate TCI state of non-serving cell or not. Serving cell 620 may indicate one or more TCI states of non-serving cell which can be activated based on report from UE 610 or alternately serving cell 620 can send the report to non-serving cell 630 and non-serving cell 630 indicates the TCI state to be activated to serving cell 610. In an alternate embodiment, determination of TCI state of non-serving cell to be activated can be taken by serving cell 620 itself based on report from UE 610.

In step 645, serving cell 620 indicates to UE 610 the TCI state of non-serving cell to be activated. The indication can be via PDCCH or MAC CE. MAC CE may include one or more of TCI state ID, corset ID, cell identification.

In step 655, UE 610 may receive PDCCH order after/together with the TCI state update indication.

Upon receiving the first PDCCH order (for TAG of cell or for PTAG) after/together with the TCI state update indication, the UE 610 may perform at least one of the following steps:

In step 665-1, Option 1: UE 610 stops the timeAlignmentTimer associated with TAG (timing advanced group) of the non-serving cell, if running. TAG of the non-serving cell is indicated in configuration of the non-serving cell received from gNB

In step 665-2, Option 2: If the TCI state update indication of non-serving cell is restricted to SpCell or PTAG, UE 610 stops the timeAlignmentTimer associated with PTAG, if running.

In step 665-3, Option 3: UE 610 stops the timeAlignmentTimer (if running) associated with TAG of the non-serving cell, if the TAG of the non-serving cell is PTAG. TAG of the non-serving cell is indicated in configuration of the non-serving cell received from gNB

In step 676, and step 685, UE 610 then initiate random access procedure.

According to various embodiments of this disclosure, in one method of this disclosure, UE maintains two timing alignment timers for a TAG of a serving cell.

UE may maintain at least one of timeAlignmentTimer (corresponds to TRP 1) or timeAlignmentTimer2 (corresponds to TRP 2), wherein serving cell with PCI X has two TRPs, TRP 1 with PCI X and TRP 2 having a PCI different than PCI X.

In one embodiment, when UE receives TCI state update indication for the serving cell, activating TCI state/beam of TRP1/TRP 2, and if timing alignment timer of TRP whose TCI state is activated is not running, at least one of following steps can be performed:
UE may initiate random access procedure or wait for PDCCH order to initiate random access procedure; or

Alternately network may indicate whether to perform random access procedure (in L1/L2 signal or RRC message).

In one embodiment, while the TCI state of TRP1 of serving cell is active, and if UE receives TA command in RAR or TA command in MsgB or TA MAC CE for the serving cell, at least one of following steps can be performed:
UE may start or restart the timeAlignmentTimer; or
UE applies the received TA for TRP1.

In one embodiment, while the TCI state of TRP2 of serving cell is active, and if UE receives TA command in RAR or TA command in MsgB or TA MAC CE for the serving cell, at least one of following steps can be performed:
UE may start or restart the timeAlignmentTimer2; or
UE applies the received TA for TRP2.

According to various embodiments of this disclosure, in one embodiment of this disclosure, UE initiates random access procedure towards a cell.

UE receives timing advanced command in random access response message or in MsgB in following procedures:

When a Timing Advance Command is received in a Random Access Response message for a Serving Cell belonging to a TAG or in a MSGB for an SpCell or when a Timing Advance Command is received in a Random Access Response message for a non Serving Cell belonging to a TAG or in a MSGB for a non Serving Cell belonging to PTAG, following operations can be performed:

If the Random Access Preamble was not selected by the MAC entity among the contention-based Random Access Preamble, UE may apply the Timing Advance Command for this TAG; and/or UE may start or restart the timeAlignmentTimer associated with this TAG; or

Else if the timeAlignmentTimer associated with this TAG is not running, UE may apply the Timing Advance Command for this TAG; and/or UE may start the timeAlignmentTimer associated with this TAG. Furthermore, when the Contention Resolution is considered not successful; or when the Contention Resolution is considered successful for SI request after transmitting HARQ feedback for MAC PDU including UE Contention Resolution Identity MAC CE, UE may stop timeAlignmentTimer associated with this TAG.

In the above operation, non-serving cell can also be referred as a TRP with different PCI than the PCI of serving cell (or PCI of TRP of serving cell).

According to various embodiments of this disclosure, in one embodiment of this disclosure, UE initiates random access procedure towards a cell.

UE receives timing advanced command in random access response message or in MsgB in following procedures:

In one embodiment, when a Timing Advance Command is received in a Random Access Response message for a Serving Cell belonging to a TAG or in a MSGB for an SpCell, following operations can be performed:

If the Random Access Preamble was not selected by the MAC entity among the contention-based Random Access Preamble, UE may apply the Timing Advance Command for this TAG; and/or UE start or restart the timeAlignmentTimer associated with this TAG.

Else if the timeAlignmentTimer associated with this TAG is not running, UE may apply the Timing Advance Command for this TAG and/or UE may start the timeAlignmentTimer associated with this TAG. Furthermore, when the Contention Resolution is considered not successful; or when the Contention Resolution is considered successful for SI request as described in clause 5.1.5, after transmitting HARQ feedback for MAC PDU including UE Contention Resolution Identity MAC CE, UE may stop timeAlignmentTimer associated with this TAG.

In one embodiment, when a Timing Advance Command is received in a Random Access Response message for a non Serving Cell belonging to a TAG or in a MSGB for a non Serving Cell belonging to PTAG, UE may apply the Timing Advance Command for this TAG; and/or UE may start the timeAlignmentTimer associated with this TAG. Furthermore, when the Contention Resolution is considered not successful, UE may stop timeAlignmentTimer associated with this TAG.

In the above operation, non-serving cell can also be referred as a TRP with different PCI than the PCI of serving cell (or PCI of TRP of serving cell).

FIG. 7 illustrates a block diagram illustrating a structure of a UE according to an embodiment of the disclosure.

As shown in FIG. 7, the UE according to an embodiment may include a transceiver 710, a memory 720, and a processor 730. The transceiver 710, the memory 720, and the processor 730 of the UE may operate according to a communication method of the UE described above. However, the components of the UE are not limited thereto. For example, the UE may include more or fewer components than those described above. In addition, the processor 730, the transceiver 710, and the memory 720 may be implemented as a single chip. Also, the processor 730 may include at least one processor.

The transceiver 710 collectively refers to a UE receiver and a UE transmitter, and may transmit/receive a signal to/from a base station or a network entity. The signal transmitted or received to or from the base station or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the UE. Also, the memory 720 may store control information or data included in a signal obtained by the UE. The memory 720 may be a storage medium, such as read-only memory (ROM), random access memory (RAM), a hard disk, a CD-ROM, and a DVD, or a combination of storage media.

The processor 730 may control a series of processes such that the UE operates as described above. For example, the transceiver 710 may receive a data signal including a control signal transmitted by the base station or the network entity, and the processor 730 may determine a result of receiving the control signal and the data signal transmitted by the base station or the network entity.

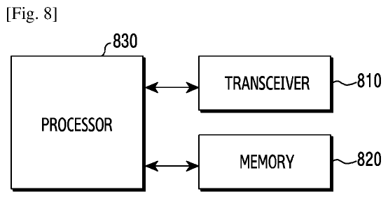

FIG. 8 illustrates a block diagram illustrating a structure of a base station (BS) according to an embodiment of the disclosure.

As shown in FIG. 8, the base station according to an embodiment may include a transceiver 810, a memory 820, and a processor 830. The transceiver 810, the memory 820, and the processor 830 of the base station may operate according to a communication method of the base station described above. However, the components of the base station are not limited thereto. For example, the base station may include more or fewer components than those described above. In addition, the processor 830, the transceiver 810, and the memory 820 may be implemented as a single chip. Also, the processor 830 may include at least one processor.

The transceiver 810 collectively refers to a base station receiver and a base station transmitter, and may transmit/receive a signal to/from a terminal or a network entity. The signal transmitted or received to or from the terminal or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the base station. Also, the memory 820 may store control information or data included in a signal obtained by the base station. The memory 820 may be a storage medium, such as read-only memory (ROM), random access memory (RAM), a hard disk, a CD-ROM, and a DVD, or a combination of storage media.

The processor 830 may control a series of processes such that the base station operates as described above. For example, the transceiver 810 may receive a data signal including a control signal transmitted by the terminal, and the processor 830 may determine a result of receiving the control signal and the data signal transmitted by the terminal.

According to various embodiments of this disclosure, a method performed by a user equipment (UE) in a wireless communication system, the method comprising: receiving, from a base station associated with a serving cell, a configuration of a non-serving cell, generating a beam measurement report of the non-serving cell based on the configuration, transmitting, to the base station associated with the serving cell, the generated beam measurement report of the non-serving cell, receiving, from the base station associated with the serving cell, information on a transmission configuration indicator (TCI) state indicates TCI state of the non-serving cell, based on the beam measurement report, stopping a time alignment timer associated with the serving cell based on the information on the TCI state, and performing random access procedure on the non-serving cell based on the information on the TCI state.

In one embodiment, further comprising: identifying whether the received information on the TCI state indicates the non-serving cell via L1/L2 signaling.

In one embodiment, further comprising: receiving, from a base station associated with the non-serving cell, physical downlink control channel (PDCCH) order, and performing random access procedure on the non-serving cell based on the information on the TCI state and the PDCCH order.

In one embodiment, wherein the time alignment timer is associated at least one of: timing advanced group (TAG) of the non-serving cell, or primary TAG (PTAG) of the non-serving cell.

In one embodiment, wherein a PCI (physical cell identity) of the non-serving cell is different from a PCI of the serving cell.

In one embodiment, wherein the information on the TCI state includes at least one of: indication to initiate random access procedure on the non-serving cell, or indication to stop the time alignment timer associated with the serving cell.

According to various embodiments of this disclosure, a method performed by a base station associated with a serving cell in a wireless communication system, the method comprising: transmitting, to a user equipment (UE), a configuration of a non-serving cell, receiving, from the UE, a beam measurement report of the non-serving cell based on the configuration of the non-serving cell, identifying a transmission configuration indicator (TCI) state of the non-serving cell based on the received beam measurement report; and transmitting, to the UE, information on the identified TCI state of the non-serving cell, wherein the information on the TCI state of the non-serving cell indicates the UE to stop a time alignment timer associated with the serving cell.

In one embodiment, wherein the information on the TCI state of the non-serving cell is transmitted via L1/L2 signaling.

In one embodiment, wherein the time alignment timer is associated at least one of: timing advanced group (TAG) of the non-serving cell, or primary TAG (PTAG) of the non-serving cell.

In one embodiment, wherein a PCI (physical cell identity) of the non-serving cell is different from a PCI of the serving cell.

In one embodiment, wherein the information on the TCI state includes at least one of: indication to initiate random access procedure on the non-serving cell, or indication to stop the time alignment timer associated with the serving cell.

According to various embodiments of this disclosure, a user equipment (UE) in a wireless communication system, the UE comprising: at least one transceiver; and at least one processor operably coupled with the at least one transceiver, wherein the at least one processor is configured to: receive, from a base station associated with a serving cell, a configuration of a non-serving cell; generate a beam measurement report of the non-serving cell based on the configuration; transmit, to the base station associated with the serving cell, the generated beam measurement report of the non-serving cell; receive, from the base station associated with the serving cell, information on a transmission configuration indicator (TCI) state indicates TCI state of the non-serving cell, based on the beam measurement report; stop a time alignment timer as sociated with the serving cell based on the information on the TCI state; and perform random access procedure on the non-serving cell based on the information on the TCI state.

In one embodiment, wherein the at least one processor is further configured to: identify whether the received information on the TCI state indicates the non-serving cell via L1/L2 signaling.

In one embodiment, wherein the at least one processor is further configured to: receive, from the non-serving cell, physical downlink control channel (PDCCH) order; and perform random access procedure on the non-serving cell based on the information on the TCI state and the PDCCH order.

According to various embodiments of this disclosure, a base station (BS) associated with a serving cell in a wireless communication system, the BS comprising: at least one transceiver; and at least one processor operably coupled with the at least one transceiver, wherein the at least one processor is configured to: transmit, to a user equipment (UE), a configuration of a non-serving cell; receive, from the UE, a beam measurement report of the non-serving cell based on the configuration of the non-serving cell; identify a transmission configuration indicator (TCI) state of the non-serving cell based on the received beam measurement report; and transmit, to the UE, information on the identified TCI state of the non-serving cell, wherein the information on the TCI state of the non-serving cell indicates the UE to stop a time alignment timer associated with the serving cell.

Methods according to embodiments stated in claims and/or specifications of the disclosure may be implemented in hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or other type optical storage devices, or a magnetic cassette. Alternatively, any combination of some or all of the may form a memory in which the program is stored. Further, a plurality of such memories may be included in the electronic device.

In addition, the programs may be stored in an attachable storage device which is accessible through communication networks such as the Internet, Intranet, local area network (LAN), wide area network (WAN), and storage area network (SAN), or a combination thereof. Such a storage device may access the electronic device via an external port. Further, a separate storage device on the communication network may access a portable electronic device.

In the above-described detailed embodiments of the disclosure, a component included in the disclosure is expressed in the singular or the plural according to a presented detailed embodiment. However, the singular form or plural form is selected for convenience of description suitable for the presented situation, and various embodiments of the disclosure are not limited to a single element or multiple elements thereof. Further, either multiple elements expressed in the description may be configured into a single element or a single element in the description may be configured into multiple elements.

While the disclosure has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and equivalents thereof.

1. A method performed by a user equipment (UE) in a wireless communication system, the method comprising:
receiving, from a base station associated with a serving cell, a configuration of a non-serving cell;
generating a beam measurement report of the non-serving cell based on the configuration;
transmitting, to the base station associated with the serving cell, the generated beam measurement report of the non-serving cell;
receiving, from the base station associated with the serving cell, information on a transmission configuration indicator (TCI) state indicates TCI state of the non-serving cell, based on the beam measurement report;
stopping a time alignment timer associated with the serving cell based on the information on the TCI state; and
performing random access procedure on the non-serving cell based on the information on the TCI state.

2. The method of claim 1, further comprising:
identifying whether the received information on the TCI state indicates the non-serving cell via L1/L2 signaling.

3. The method of claim 1, further comprising:
receiving, from a base station associated with the non-serving cell, physical downlink control channel (PDCCH) order; and
performing random access procedure on the non-serving cell based on the information on the TCI state and the PDCCH order.

4. The method of claim 1, wherein the time alignment timer is associated at least one of:
timing advanced group (TAG) of the non-serving cell; or
primary TAG (PTAG) of the non-serving cell.

5. The method of claim 1, wherein a PCI (physical cell identity) of the non-serving cell is different from a PCI of the serving cell.

6. The method of claim 1, wherein the information on the TCI state includes at least one of:
indication to initiate random access procedure on the non-serving cell; or
indication to stop the time alignment timer associated with the serving cell.

7. A method performed by a base station associated with a serving cell in a wireless communication system, the method comprising:
transmitting, to a user equipment (UE), a configuration of a non-serving cell;
receiving, from the UE, a beam measurement report of the non-serving cell based on the configuration of the non-serving cell;
identifying a transmission configuration indicator (TCI) state of the non-serving cell based on the received beam measurement report; and
transmitting, to the UE, information on the identified TCI state of the non-serving cell,
wherein the information on the TCI state of the non-serving cell indicates the UE to stop a time alignment timer associated with the serving cell.

8. The method of claim 7, wherein the information on the TCI state of the non-serving cell is transmitted via L1/L2 signaling.

9. The method of claim 7, wherein the time alignment timer is associated at least one of:
timing advanced group (TAG) of the non-serving cell; or
primary TAG (PTAG) of the non-serving cell.

10. The method of claim 7, wherein a PCI (physical cell identity) of the non-serving cell is different from a PCI of the serving cell.

11. The method of claim 7, wherein the information on the TCI state includes at least one of:
indication to initiate random access procedure on the non-serving cell; or
indication to stop the time alignment timer associated with the serving cell.

12. A user equipment (UE) in a wireless communication system, the UE comprising:
at least one transceiver; and
at least one processor operably coupled with the at least one transceiver,
wherein the at least one processor is configured to:
receive, from a base station associated with a serving cell, a configuration of a non-serving cell;
generate a beam measurement report of the non-serving cell based on the configuration;
transmit, to the base station associated with the serving cell, the generated beam measurement report of the non-serving cell;
receive, from the base station associated with the serving cell, information on a transmission configuration indicator (TCI) state indicates TCI state of the non-serving cell, based on the beam measurement report;
stop a time alignment timer associated with the serving cell based on the information on the TCI state; and
perform random access procedure on the non-serving cell based on the information on the TCI state.

13. The UE of claim 12, wherein the at least one processor is further configured to:
identify whether the received information on the TCI state indicates the non-serving cell via L1/L2 signaling.

14. The UE of claim 12, wherein the at least one processor is further configured to:
receive, from the non-serving cell, physical downlink control channel (PDCCH) order; and
perform random access procedure on the non-serving cell based on the information on the TCI state and the PDCCH order.

15. A base station (BS) associated with a serving cell in a wireless communication system, the BS comprising:
at least one transceiver; and
at least one processor operably coupled with the at least one transceiver,
wherein the at least one processor is configured to:
transmit, to a user equipment (UE), a configuration of a non-serving cell;
receive, from the UE, a beam measurement report of the non-serving cell based on the configuration of the non-serving cell;
identify a transmission configuration indicator (TCI) state of the non-serving cell based on the received beam measurement report; and
transmit, to the UE, information on the identified TCI state of the non-serving cell,
wherein the information on the TCI state of the non-serving cell indicates the UE to stop a time alignment timer associated with the serving cell.
